(19) United States
(12) Patent Application Publication
(10) Pub. No.: US 2006/0234825 A1
(43) Pub. Date: Oct. 19, 2006

(54) Self-regulating continuously variable transmission

(76) Inventor: Clifford Orval Daniels, Calgary (CA)

Correspondence Address: CLIFFORD ORVAL DANIELS, 170 JARVIS ST., TORONTO, ON, M5B 2B7, CA

(21) Appl. No.: 11/107,975

(22) Filed: Apr. 18, 2005

(51) Int. Cl. F16H 37/06

(52) U.S. Cl. 475/330

(57) ABSTRACT

A flexible mechanical linkage between two rotating shafts which allows one, the torque output shaft, to rotate at an angular velocity equal to, or variably lesser than the other, the torque input shaft. Such devices are commonly refereed to as continuously variable transmissions. In this invention, a limited range of loads greater than torque input inherently cause the output shaft to rotate at a lesser velocity than the input shaft. This difference in velocities between the two shafts is proportional to the ratio of load over torque input and causes this device to adjust operation to compensate for the ratio of load over torque input. All component movements are rotational so that all mass movements are fully counter-balanced by the mass movements of other components and friction between components is eliminated by ring type roller or ball bearings. All components are well supported to withstand high torsional loads. This invention is simple, inexpensive to manufacture, compact, lightweight, offers a wide range of torque multiplication ratios, and in automotive applications, transmits engine-braking force.

### BACKGROUND

Currently, in automotive propulsion systems and some stationary applications where fluctuating loads are encountered, torque transmission systems with a limited number of torque multiplication ratios are used. An operator or control mechanism must select the appropriate torque multiplication ratio to compensate for any difference between available torque and load conditions. Also, the number of torque multiplication ratios are limited, thus the engine providing torque must operate over a wide range of load conditions and rotational velocities. This adversely affects engine efficiency as most power generating systems operate most efficiently in a narrow range of load conditions and rotational velocities. Operator or control mechanism input is also required to select the proper torque multiplication ratio for changing load conditions.

While numerous continuously variable transmissions have been invented, including at least one self-regulating type, all have some serious drawback such as the generation of vibration or excessive friction or the lack of structural strength and are thus limited in the amount of torque that can be transmitted.

### DRAWING

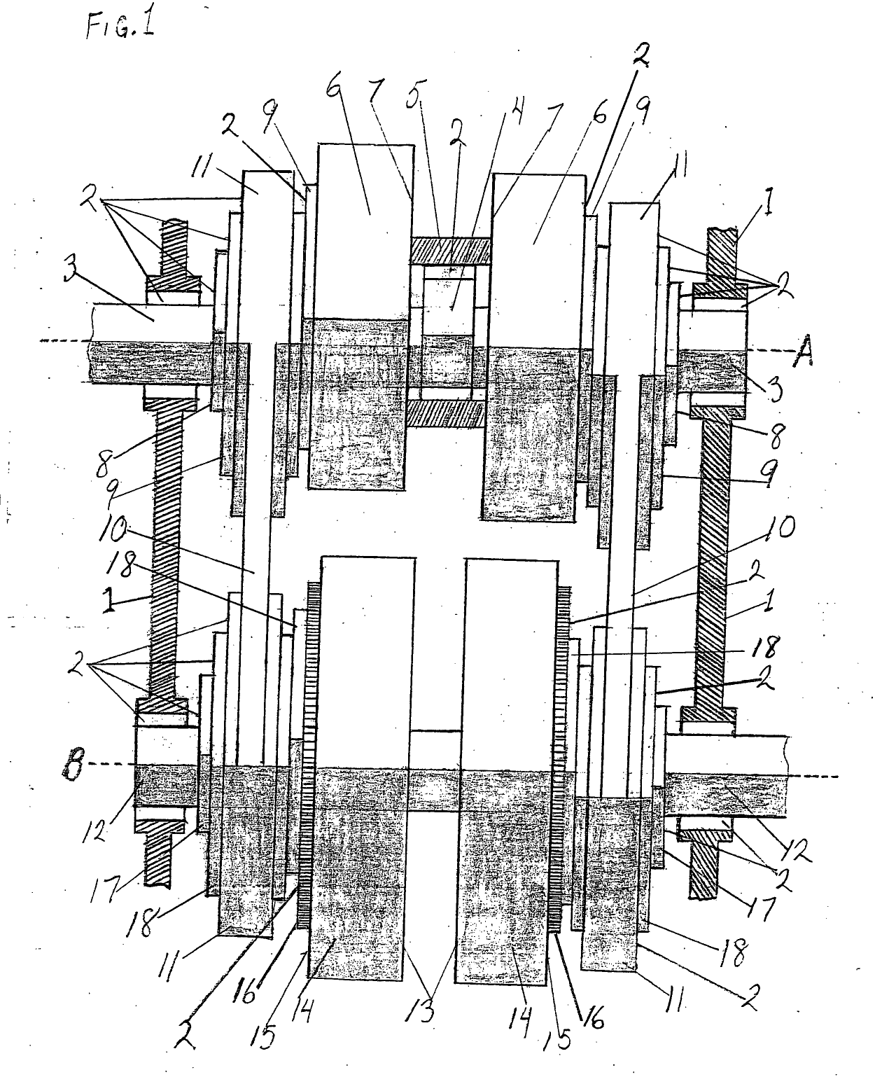

In the drawing (FIG. 1) the viewer's line of sight is at a ninety-degree right angle relative to the rotational and orbital axes of all of the components. All of the shaded components are cylinders viewed from a ninety-degree right angle relative to the length axes of said cylinders. Illumination is from directly above. Thus, the lower halves of said cylinders are shaded and the demarcation between shaded and unshaded cylinder represent the diameter axis center of said cylinder. Said demarcation also demonstrates the distance of offset between each said diameter axis center and either axis A or axis B and the diameter axis centers of the other cylindrical components.

The inner distal components are wider than the outer proximal components so that said distal components project out from said proximal components to reveal said distal components.

The proximal half of the torque divider central bearing ring (5) and the bearing (2) between said ring (5) and input throw cam (4) have been removed to reveal throw cam (4), part of input shaft (3) and also a cross sectional view of said ring (5) and bearing (2).

The stationary casing (1) is represented by parts of the two opposite end walls which support the input shaft (3) and output shaft (12). The proximal parts of said end walls have been removed to reveal said shafts (3) and (12) and a cross sectional view of said end walls and the bearing (2) between said walls and said shafts (3) and (12). With the exception of the said bearings (2) viewed in cross section, all bearings (2) are inside outer components and are therefore not visible. The numbered lines (2) contact said outer components at a point in the outer circumference of the respective bearing (2) on which said outer component is supported.

The throw radii of the input throw cam (4), secondary crank throw cams (9) and tertiary crank throw cams (18) are one eighth of one inch.

The radii of offset between the diameter axis centers of the secondary crankshaft carrier cams (8) and axis (A) are one eighth of one inch. The radii of offset between the diameter axis centers of the tertiary crankshaft carrier cams (17) and axis (B) are one eighth of one inch.

The radius of orbit of the planetary gears (16) is one eighth of one inch thus the difference in diameter between the lesser planetary gears (16) and greater ring gears (15) is one quarter of one inch.

Rings (14) are four inches in diameter and have a radial thickness of one quarter of one inch thus the inner diameter of rings (14) and hence the diameter of internal ring gears (15) is three and one half inches and the diameter of the external planetary gears (16) is three and one quarter inches. The ring gears (15) are inside rings (14) and are therefore not visible. The numbered lines (15) contact ring (14) at a point in the circumference of ring gears (15) diametrically opposite to the point where the ring gears (15) intermesh with planetary gears (16).

### SUMMARY

The basic principle of this invention is that a flexible mechanical linkage between two parallel rotating shafts will allow one, the torque output shaft (12) to rotate at an angular velocity equal to, or variably lesser than the other, the torque input shaft (3). Loads against output shaft (12) rotation greater than the torque exerted by the input shaft (3) would inherently cause output shaft (12) to rotate at a lesser velocity than input shaft (3). Said difference in velocity between shaft (3) and shaft (12) would be proportional to the ratio of load over torque input and would deflect movement of said mechanical linkage from the primary direct drive torque movement into the secondary torque multiplication movement. Maximum torque multiplication occurs when all torque movement is deflected into said secondary movement. Both said movements are rotational and in the angular direction of torque input but occur around different axes.

The input axis (A) assembly of components consists of an input shaft (3), throw cam(4), two secondary crankshafts (cams 9), two secondary crankshaft carriers (8) and a torque divider (rings 5 and 6). All said components are connected to each other by bearings (2) to allow independent rotation of said components relative to each other.

Input shaft (3) is mounted by bearings (2) in the two opposite end walls of stationary casing (1) and is driven in rotation around the length axis (A) of shaft (3) by a torque source.

Input throw cam (4) is a short cylinder, which has a larger diameter than shaft (3) and is an integral part of shaft (3). The length axis of cam (4) is parallel to axis (A) and the diameter center of cam (4) is offset from axis (A). Thus a crankshaft is formed which has a throw radius equal to the distance of said offset.

Two secondary crankshaft carriers (8) are mounted by bearings (2) on shaft (3), one on each side of throw cam (4). Carriers (8) are two short cylinders, which have larger diameters than shaft (3). The length axes of carriers (8) are parallel to axis (A) and the diameter center of each carrier (8) is offset from axis (A). The distance of said offset is equal to said throw radius of throw cam (4). The direction of said offset of each carrier (8) is diametrically opposite to the direction of said offset of the other carrier (8) relative to axis (A). Carriers (8) operate over a range of movement from zero degrees of rotation around axis (A) during maximum torque multiplication to; one degree of rotation around axis (A) per one degree of torque input rotation during direct drive. Each carrier (8) provides a rotational axis for one secondary crankshaft.

Each said secondary crankshaft is mounted by a bearing (2) on the circumference of one carrier (8). Each said secondary crankshaft consists of two throw cams (9). Each throw cam (9) is a short cylinder, which has a larger diameter than the carrier (8) to which cam (9) is mounted. Said two throw cams (9) form an integral unit. The length axes of cams (9) are parallel to axis (A). The two diameter centers of cams (9) are offset from the diameter axis center of the respective carrier (8) to which said secondary crankshaft is mounted. The distance of said offset is equal to said throw radius of input throw cam (4). The direction of said offset of each throw cam (9) is diametrically opposite to the direction of offset of the other throw cam (9) relative to the said diameter centre of carrier (8). Thus, each two integral throw cams (9) form a crankshaft with two diametrically opposed throws.

Said secondary crankshafts orbit around axis (A) during direct drive or each said crankshaft rotates around said diameter center of one carrier (8) during maximum torque multiplication or a combination of said two movements.

The torque divider is mounted by a bearing (2) on the circumference of input cam (4) and acts as a short connecting rod, which transmits torque from input axis (A) to one throw cam (9) of each said secondary crankshaft. Said torque divider also acts as a lever with input cam (4) being the length axis center and fulcrum of said lever and each opposite end of said divider being two opposite radial arms of said lever. Thus, torque reaction from each said secondary crankshaft exerts a load against each said radial arm of said lever so that torque reaction from each said secondary crankshaft combines with primary torque input from input cam (4) to drive the other said secondary crankshaft in the angular direction of torque input.

Said torque divider consists of three hollow cylinders, which form an integral unit. One said cylinder, the divider central ring (5) is mounted on input cam (4) so that the inner circumference of said cylinder is supported by a bearing (2) on the circumference of cam (4). One divider end ring (6), with disc (7) is an integral part of each length axis end of central ring (5). The length axes of both end rings (6) are parallel to the length axis of central ring (5) and axis (A). End rings (6) have a larger diameter than central ring (5) and the diameter center of each end ring (6) is offset from the diameter center of central ring (5). The distance of said offset is equal to said throw radius of input cam (4). The direction of said offset of each end ring (6) is diametrically opposite to the direction of offset of the other end ring (6) relative to said cam (4) and ring (5) diameter center. One throw cam (9) of each secondary crankshaft is inserted inside each end ring (6) so that the inner circumference of each end ring (6) is supported by a bearing (2) on the circumference of one throw cam (9).

Said torque divider transmits torque through one primary orbital movement, which is equal to torque input velocity and a secondary rotational movement, which is variable Said secondary crankshafts orbit around axis (A) during direct drive or each said crankshaft rotates around said diameter center of one carrier (8) during maximum torque multiplication or a combination of said two movements.

The torque divider is mounted by a bearing (2) on the circumference of input cam (4) and acts as a short connecting rod, which transmits torque from input axis (A) to one throw cam (9) of each said secondary crankshaft. Said torque divider also acts as a lever with input cam (4) being the length axis center and fulcrum of said lever and each opposite end of said divider being two opposite radial arms of said lever. Thus, torque reaction from each said secondary crankshaft exerts a load against each said radial arm of said lever so that torque reaction from each said secondary crankshaft combines with primary torque input from input cam (4) to drive the other said secondary crankshaft in the angular direction of torque input.

Said torque divider consists of three hollow cylinders, which form an integral unit. One said cylinder, the divider central ring (5) is mounted on input cam (4) so that the inner circumference of said cylinder is supported by a bearing (2) on the circumference of cam (4). One divider end ring (6), with disc (7) is an integral part of each length axis end of central ring (5). The length axes of both end rings (6) are parallel to the length axis of central ring (5) and axis (A). End rings (6) have a larger diameter than central ring (5) and the diameter center of each end ring (6) is offset from the diameter center of central ring (5). The distance of said offset is equal to said throw radius of input cam (4). The direction of said offset of each end ring (6) is diametrically opposite to the direction of offset of the other end ring (6) relative to said cam (4) and ring (5) diameter center. One throw cam (9) of each secondary crankshaft is inserted inside each end ring (6) so that the inner circumference of each end ring (6) is supported by a bearing (2) on the circumference of one throw cam (9).

Said torque divider transmits torque through one primary orbital movement, which is equal to torque input velocity and a secondary rotational movement, which is variable depending on the load over torque ratio. During direct drive, the two said secondary crankshafts and end rings (6) orbit around axis (A) at input velocity. Loads greater than torque input cause said secondary crankshafts to orbit around axis (A) at a lesser velocity than torque input.

At lower orbital velocities, torque movement is deflected into driving each said secondary crankshaft in rotation around each respective said diameter center of one carrier (8). Maximum torque multiplication occurs when all torque movement is deflected into driving said secondary crankshafts in rotation around said diameter centers of carriers (8) and carriers (8) are stationery relative to axis (A). In this mode of operation, all torque movement is around two separate axes. Each said separate axis is equal distance from axis (A) and is diametrically opposite to the other said axis relative to axis (A).

One end ring (11) of one of two connecting rods (10) is supported by a bearing (2) on the circumference of one throw cam (9) and together with the other connecting rod (10), transmit torque from axis (A) to axis (B).

Said two axes offset from axis (A) can't counter-rotate around axis (A) as each connecting rod (10) transmits torque equally to axis (B) and both rods (10) always travel in the angular direction of torque input around the different said axes. Thus any counter-rotation of said axes offset from axis (A) would reduce the velocity and distance of one connecting rod stroke and increase the velocity and distance of stroke of the other rod (10) between axis (A) and axis (B). This is impossible as two different velocities of torque movement would be exerted to a single output shaft (12) assembly.

The axis (B) assembly of components consists of an output shaft (12), two ring support discs (13), two rings (14), two ring gears (15), two planetary gears (16), two tertiary crankshaft carriers (17) and two tertiary crankshaft (cams 18). Output shaft (12) is supported by bearings (2) in the two opposite end walls of stationery casing (1) and rotates on the length axis (B) of shaft (12). Shaft (12) drives said load in the angular direction of torque input. Ring support discs (13), rings (14) and internal ring gears (15) are integral parts of shaft (12), which forms the rotational axis and diameter center of said components.

Each ring (14) is one of two hollow cylinders, which are connected to shaft (12) by disc (13). One internal ring gear (15) is located on the inner circumference of each ring (14).

Two tertiary crankshaft carriers (17) are mounted by bearings (2) on output shaft (12), one on one side of each disc (13). Tertiary carriers (17) are two short cylinders, which have a larger diameter than shaft (12). The length axes of said cylinders are parallel to axis (B) and the diameter center of each carrier (17) is offset from axis (B). The distance of said offset is equal to said throw radius of input cam (4). The direction of said offset of each carrier (17) is diametrically opposite to the direction of said offset of the other carrier (17) relative to axis (B) The direction of said offset of each carrier (17) is parallel to the direction of said offset of the corresponding secondary carrier (8) relative to axis (A). Carriers (17) operate over a range of movement from zero degrees of rotation around axis (B) during maximum torque multiplication to; one degree of rotation around axis (B) per one degree of torque input rotation during direct drive.

Each carrier (17) provides a rotational axis for one tertiary crankshaft. Each tertiary crankshaft is mounted by a bearing (2) on the circumference of one carrier (17). Each said tertiary crankshaft consists of two throw cams (18). Each throw cam (18) is a short cylinder, which has a larger diameter than the carrier (17) to which each cam (18) is mounted. Said two throw cams (18) form an integral unit. The length axis of cams (18) are parallel to axis (B). The two diameter centers of cams (18) are offset from the diameter center of the respective carrier (17) to which each said tertiary crankshaft is mounted. The distance of said offset is equal to said throw radius of input cam (4). The direction of said offset of each throw cam (18) is diametrically opposite to the direction of said offset of the other throw cam (18) relative to the said diameter center of carrier (17). Thus, each two integral throw cams (18) form a crankshaft with two diametrically opposed throws.

Said tertiary crankshafts orbit around axis (B) during direct drive or each said crankshaft rotates around said diameter center of one carrier (17) during maximum torque multiplication or a combination of said two movements.

One end ring (11) of one connecting rod (10) is supported by a bearing (2) on the circumference of one throw cam (18) if each said tertiary crankshaft, which receives torque from axis (A).

One planetary gear (16) is mounted by a bearing (2) on the circumference of one tertiary throw cam (18). Each planetary gear (16) is a short cylinder which has external gear teeth around the circumference and the diameter axis of said cylinder is at a ninety-degree right angle relative to axis (B) and the length axis of throw cams (18). The diameter center of each planetary gear (16) is offset from the diameter center of the respective throw cam (18) to which each gear (16) is mounted. The distance of said offset is equal to said throw radius of input cam (4). The direction of said offset is diametrically opposite to the direction of said offset of each respective carrier (17) relative to axis (B). Thus, said gears (16) diameter centers orbit around axis (B) whether gears (16) are driven in rotation around axis (B) or each gear (16) is driven around said offset diameter center of said respective carrier (17) to which each gear (17) is connected by one said tertiary crankshaft.

External planetary gears (16) have a lesser diameter than the internal ring gears (15) to which gears (16) are intermeshed and drive gears (15) through the two said movements.

During direct drive, when ring gears (15) rotate around axis (B) at input torque velocity, planetary gears (16) orbit and rotate around axis (B) at input torque velocity. Loads greater than torque input inherently cause ring gears (15) to rotate at a lesser velocity than torque input. To compensate for said difference in velocity, planetary gear (16) rotation around axis (B) is reduced in velocity while orbital velocity remains equal to torque input velocity.

During maximum torque multiplication, planetary gear (16) rotation around axis (B) is reduced to zero and all torque transmission is by planetary gear (16) orbit around axis (B). This is the equivalent of the lesser diameter planetary gears (16) counter-rotating in the opposite direction of torque input one full counter-rotation per one full orbit around axis (B) of planetary gears (16) in the angular direction of torque input. Thus, planetary gears (16) with a diameter equal to seventy-five percent of the diameter of ring gears (15) would compensate for seventy-five percent of torque input rotation leaving twenty-five percent to drive ring gears (15) and thus the load.

Thus a continuously variable transmission is created which has a maximum torque multiplication ratio of one to four and a maximum angular velocity reduction of four to one.

The mass of the two connecting rods (10) is always diametrically opposite to the mass of both said torque divider on axis (A) and the mass of the planetary gears (16) on axis (B) during both said movements or a combination of said movements. Thus, the mass of rods (10) counter-balance the mass of said torque divider on axis (A) and the mass of planetary gears (16) on axis (B) during both said movements or a combination of said movements.

### DETAILED DESCRIPTION OF INVENTION

1. Stationary Casing

Said casing (1) provides a stationary mount for the input shaft (3) and output shaft (12) and encloses all moving components in a lubricating oil bath.

2. Bearings

Said bearings (2) are ring shaped roller or ball type. Said bearings (2) eliminate friction between the various components.

3. Input Shaft

Said shaft (3) is an elongated cylinder which is supported by bearings (2) in two opposite end walls of casing (1). Shaft (3) is driven in rotation around the length axis (A) by a torque source.

4. Input Throw Cam

Said cam (4) is a short cylinder, which is an integral part of shaft (3). Cam (4) has a larger diameter than shaft (3) and the diameter axis of cam (4) is at a ninety degree right angle relative to said rotational axis (A) of shaft (3). The diameter center of cam (4) is offset from said axis (B) so that, with shaft (3) rotation, the said diameter center of cam (4) orbits around said rotational axis (A) creating a crankshaft with a throw radius equal to the distance of said offset.

Torque Divider

Said torque divider consists of the following integral components.

### DETAILED DESCRIPTION OF INVENTION

1. Stationary Casing

Said casing (1) provides a stationary mount for the input shaft (3) and output shaft (12) and encloses all moving components in a lubricating oil bath.

2. Bearings

Said bearings (2) are ring shaped roller or ball type. Said bearings (2) eliminate friction between the various components.

3. Input Shaft

Said shaft (3) is an elongated cylinder which is supported by bearings (2) in two opposite end walls of casing (1). Shaft (3) is driven in rotation around the length axis (A) by a torque source.

4. Input Throw Cam

Said cam (4) is a short cylinder, which is an integral part of shaft (3). Cam (4) has a larger diameter than shaft (3) and the diameter axis of cam (4) is at a ninety degree right angle relative to said rotational axis (A) of shaft (3). The diameter center of cam (4) is offset from said axis (B) so that, with shaft (3) rotation, the said diameter center of cam (4) orbits around said rotational axis (A) creating a crankshaft with a throw radius equal to the distance of said offset.

Torque Divider

Said torque divider consists of the following integral components.

5. Divider Central Ring

Said ring (5) is a short hollow cylinder which is mounted on throw cam (4) so that the inner circumference of said cylinder is supported by a bearing (2) on the circumference of cam (4).

6. Divider End Rings

Said rings (6) are two hollow cylinders. Each ring (6), with one disc (7) is an integral part of each length axis end of central ring (5). The length axes of rings (6) are parallel to the length axis of central ring (5) and end rings (6) have a larger diameter than central ring (5). The diameter centers of end rings (6) are offset from the diameter center of central ring (5). The distance of said offset is equal to said throw radius of input cam (4). The direction of said offset of each end ring (6) is diametrically opposite to the direction of said offset of the other end ring (6) relative to said diameter center of central ring (5).

7. End Ring Support Discs

Each said disc (7) connects the outer circumference of each length axis end of central ring (5) with the inner circumference of one length axis end of one end ring (6).

8. Secondary Crankshaft Carriers

Said carriers (8) are two short cylinders which are mounted by bearings (2) on shaft (3), one on each side of cam (4). The length axes of carriers (8) are parallel to axis (A) and carriers (8) have a larger diameter than shaft (3). The diameter centers of carriers (8) are offset from axis (A). The distance of said offset is equal to said throw radius of input cam (4). The direction of said offset of each carrier (8) is diametrically opposite to the direction of offset of the other carrier (8) relative to axis (A). Carriers (8) rotate around axis (A) in the angular direction of torque input at variable velocities relative to torque input velocity over a range from zero to torque input velocity. Each carrier (8) provides a rotational axis for one secondary crankshaft.

Secondary Crankshafts

Each of two said secondary crankshafts consist of two of the following component:

9. Secondary Crank Throw Cams

Said throw cams (9) are two short cylinders, which form an integral unit. Said unit is mounted by bearings (2) on the circumference of each carrier (8). The length axes of cams (9) are parallel to axis (A). Cams (9) have a larger diameter than carriers (8) and the diameter center of each cam (9) is offset from said diameter center of the carrier (8) to which each integral pair of cams (9) is mounted. The distance of said offset is equal to said throw radius of input throw cam (4). The direction of said offset of each cam (9) is diametrically opposite to the direction of offset of the other cam (9) relative to said diameter center of each carrier (8) to which each integral pair of cams (9) is mounted. Thus, each two integral cams (9) form a crankshaft with two diametrically opposed throws. One throw cam (9) is located inside one divider end ring (6) so that the inner circumference of each ring (6) is supported by a bearing (2) on the circumference of each cam (9). Thus, cams (9) receive torque from rings (6). One end ring (11) of one connecting rod (10) is supported by a bearing (2) on one throw cam (9) so that the inner circumference of end ring (11) is supported by a bearing (2) on the circumference of one throw cam (9) of each said secondary crankshaft.

Said secondary crankshaft orbits around axis (A) with carrier (8) rotation around axis (A) or each said secondary crankshaft rotates around said diameter center of the carrier (8) to which each integral pair of cams (9) is mounted.

10. Connecting Rods

Said rods (10) are two elongated bars which transmit torque from the input axis (A) to the output axis (B)

11. Connecting Rod End Rings

Said rod end rings (10) are short hollow cylinders, which are integral parts of each length axis end of each connecting rod (10). The length axis of each end ring (11) is at a ninety-degree right angle relative to the length axis of each respective connecting rod (10). One end ring (11) is located at each length axis end of each connecting rod (10). One end ring (11) is supported by a bearing (2) on the circumference of one throw cam (9) so that the inner circumference of end ring (11) is supported by said bearing (2).

12. Output Shaft

Said shaft (12) is an elongated cylinder which is mounted by bearings (2) in two opposite end walls of casing (1). Shaft (12) rotates around the length axis (B) and drives a load in rotation. Axis (B) is parallel to input axis (A).

13. Ring Support Discs

Said discs (13) are two discs, which are integral parts of shaft (12). Shaft (12) forms the rotational axis and diameter center of discs (13). The diameter axes of discs (13) are at a ninety-degree right angle relative to axis (B).

14. Rings

Rings (14) are two hollow cylinders. Each ring (14) is an integral part of the circumference of one support disc (13).

15. Internal Ring Gears

Said ring gears (15) are two internal gears, which are located on the inner circumference of each ring (14).

16. External Planetary Gears

Said planetary gears (16) are two short cylinders, which have an external gear on each circumference. The cylindrical length axes of gears (16) are parallel to axes (B). Planetary gears (16) have a lesser diameter than ring gears (15) and the difference in diameter between gears (16) and gears (15) is equal to twice said throw radius of input cam (4) or twice the radius of orbit of planetary gears (16) around axis (B). Each planetary gear (16) is intermeshed with one ring gear (15) and planetary gears (16) drive ring gears (15) through two different rotational movements or a combination of said movements.

During direct drive, planetary gears (16) orbit and rotate around axis (B) in the angular direction of torque input, at torque input velocity. During maximum torque multiplication, planetary gears (16) transmit torque by orbit only and the diameter axes of gears (16) remain parallel to a fixed plane in space. Maximum torque multiplication is proportional to said difference in diameter between planetary gears (16) and ring gears (15). Planetary gears (16) with a diameter which is seventy-five percent of the diameter of ring gears (15) would have a maximum torque multiplication of one to four.

17. Tertiary Crankshaft Carriers

Said carriers (17) are two cylinders which are mounted by bearings (2) on shaft (12), one on one side of each disc (13). The length axes of carriers (17) are parallel to axis (B) and carriers (B) have larger diameters than shaft (12). The diameter centers of carriers (17) are offset from axis (B). The distance of said offset is equal to said throw radius of input cam (4). The direction of said offset of each carrier (17) is diametrically opposite to the direction of said offset of the other carrier (17) relative to axis (B). Carriers (17) rotate in the angular direction of torque input over a range of velocity from zero to torque input velocity. Each carrier (17) provides a rotational axis for one tertiary crankshaft.

Tertiary Crankshafts

Each of two said tertiary crankshafts consists of two of the following component.

18. Tertiary Crank Throw Cams

Said throw cams (18) are two short cylinders, which form an integral unit. Said unit is mounted by bearings (2) on the circumference of each carrier (17). The length axes of cams (18) are parallel to axes (B). Cams (18) have a larger diameter than carriers (17) and the diameter center of each cam (18) is offset from said diameter center of the carrier (17) to which each integral pair of cams (18) is mounted. The distance of said offset is equal to said throw radius of input cam (4). The direction of said offset of each cam (18) is diametrically opposite to the direction of offset of the other cam (18) relative to said diameter center of each carrier (17) to which each integral pair of cams (18) is mounted.

Thus, each two integral cams (9) form a crankshaft with two diametrically opposed throws. One end ring (11) of one connecting rod (10) is supported by a bearing (2) on one throw cam (18) so that the inner circumference of end ring (11) is supported by a bearing (2) on the circumference of one throw cam (18).

Thus cams (18) receive torque via connecting rods (10) from axis (A). One planetary gear (16) is mounted by a bearing (2) on the circumference of one throw cam (18) of each said tertiary crankshaft so that the diameter center of each planetary gear (16) is offset from said diameter center of the cam (18) to which each gear (16) is mounted. The distance of said offset is equal to said throw radius of input cam (4) or said offset of said diameter centers of carriers (17) from axis (B).

The direction of said offset of each planetary gear (16) is diametrically opposite to the direction of said offset, relative to axis (B), of the carrier (17) to which each gear (16) is connected.

Planetary gears (16) have a larger diameter than throw cams (18) and the diameter center of each gear (16) is offset from said diameter center of each cam (18) to which each gear (16) is mounted.

Mass Balancing

Said torque divider is of sufficient mass and radius of orbit so that said divider generates a centrifugal force equal to the centrifugal force generated by the ends of connecting rods (10) which are connected to axis (A). input cam (4). The direction of said offset of each cam (18) is diametrically opposite to the direction of offset of the other cam (18) relative to said diameter center of each carrier (17) to which each integral pair of cams (18) is mounted.

Thus, each two integral cams (9) form a crankshaft with two diametrically opposed throws. One end ring (11) of one connecting rod (10) is supported by a bearing (2) on one throw cam (18) so that the inner circumference of end ring (11) is supported by a bearing (2) on the circumference of one throw cam (18). Thus cams (18) receive torque via connecting rods (10) from axis (A). One planetary gear (16) is mounted by a bearing (2) on the circumference of one throw cam (18) of each said tertiary crankshaft so that the diameter center of each planetary gear (16) is offset from said diameter center of the cam (18) to which each gear (16) is mounted. The distance of said offset is equal to said throw radius of input cam (4) or said offset of said diameter centers of carriers (17) from axis (B).

The direction of said offset of each planetary gear (16) is diametrically opposite to the direction of said offset, relative to axis (B), of the carrier (17) to which each gear (16) is connected.

Planetary gears (16) have a larger diameter than throw cams (18) and the diameter center of each gear (16) is offset from said diameter center of each cam (18) to which each gear (16) is mounted.

Mass Balancing

Said torque divider is of sufficient mass and radius of orbit so that said divider generates a centrifugal force equal to the centrifugal force generated by the ends of connecting rods (10) which are connected to axis (A).

Said torque divider mass is always diametrically opposite to the mass of said connecting rods (10) relative to axis (A) during both said movements.

Planetary gears (16) are of sufficient mass and radius of orbit so that gears (16) generate a centrifugal force equal to the centrifugal force generated by the ends of connecting rods (10), which are connected to axis (B). Said gear (16) mass is always diametrically opposite to the mass of said connecting rods (10) relative to axis (B) during both said movements.

Alternate Method of Construction

Said alternate method of construction is the same as described except that two lesser diameter external planetary gears intermesh with a larger diameter external central sun gear. The rotational axes of said two planetary gears, is parallel to the rotational axis of said central sun gear and output shaft. Said planetary gears drive said sun gear around the output shaft diameter center of said sun gear by two different rotational movements or a combination of said movements.

During direct drive, said planetary gears orbit and rotate around said sun gear output shaft diameter center at torque input velocity. During maximum torque multiplication, each said planetary gear rotates around each diameter center of the gear shaft which forms the rotational axis of each said planetary gear, at torque input velocity. Planetary gears with a diameter equal to ninety percent of the diameter of said central sun gear would have a maximum torque multiplication ratio of one to ten and a maximum output shaft angular velocity reduction of ten to one.

Said planetary gears are supported on said output shaft by two gear carriers. Said carriers are two elongated bars, which are mounted by bearings on said output shaft, one on each side of said central sun gear. The mid-length axis center of each said carrier is mounted on said output shaft so that the length axis ends of both said carriers orbit around said output shaft. Both said planetary gears are supported by said carriers so that each length axis end of each rotational axis shaft of both said planetary gear are supported by a bearing located in each length axis end of each said carrier.

One of two connecting rods is mounted by a bearing on each said throw cam so that the inner circumference of the end ring of said connecting rod is supported by a bearing on the circumference of said throw cam. Said throw cam drives the length axis of said connecting rod in rotation around said output shaft axis center during direct drive when said tertiary crankshafts orbit around said output shaft axis or; each said throw cam drives each said connecting rod length axis in rotation around said diameter center of one said tertiary crankshaft carrier during maximum torque multiplication.

Each said rotational axis shaft of said planetary gears contains a crankshaft with a single throw cam or throw shaft offset from said axis shaft. Said crankshaft is located on one length axis end of each said rotational axis shaft, on opposite ends. The throw radius of both said crankshafts is equal to one half said throw radius of said input throw cam or one half said distance of offset of said diameter centers of said tertiary crankshaft carriers from said output shaft rotational axis center. Thus, one hundred and eighty degrees of said planetary gear crankshaft rotation would create a linear stroke equal in length to said distance of offset of said tertiary crankshaft carrier diameter center from said output shaft diameter center. Thus, said planetary gears are limited to one rotation around each individual planetary gear rotational axis per one planetary gear orbit around said output shaft.

Alternate Method of Construction

While this third method of construction lacks the structural rigidity and strength of the previous two, said third method consists of only nine moving components and is therefore considerably simpler and may be sufficient for light duty applications such as pedal bicycles etc.

In said third method, a single external planetary gear drives a single internal ring gear through two said movements of planetary gear orbit and/or rotation or a combination of said two movements.

Said planetary gear is a hollow cylinder, which has an external gear on the circumference. Said hollow cylinder is of sufficient volume and diameter to contain the input shaft, input throw cam or throw shaft, torque divider, two connecting rods, two secondary crankshafts and one secondary crankshaft carrier.

Said input shaft is mounted by at least two bearings in one end wall of the stationary casing so that the length and rotational axis of said input shaft is parallel to the output shaft but said input shaft axis is offset from the rotational and length axis of said output shaft and therefore the diameter center of said internal ring gear. Said torque divider is an elongated bar which is mounted by a bearing on the circumference of said throw cam so that the length axis of said bar is at a ninety degree right angle relative to said input shaft rotational axis.

The mid-length axis of said bar is mounted by bearing to said throw cam and the length axis ends of said bar are equidistance from said input throw cam. Said output shaft is mounted by at least two bearings in one end wall of said stationary casing opposite to said wall which supports said input shaft. Said input shaft extends inside said ring gear through a disc which supports said internal ring gear on said output shaft. Said secondary crankshaft carrier is mounted by a bearing on said output shaft extension. Said carrier is an elongated bar which is supported at the mid-length axis by said bearing and output shaft. The length axis of said bar is at a ninety-degree angle relative to said rotational axis of said output shaft. The length axis ends of said carrier are equidistance from said output shaft.

A shaft is located at each said length axis end of said carrier. The length axis of said carrier shafts are parallel to said output shaft axis.

One of two secondary crankshafts is mounted by bearings on each said carrier shaft. Each said secondary crankshaft consists of two throw cams. Said throw cams are two short cylinders, the length axis of which is parallel to said carrier shafts length axis. The diameter of said throw cams is greater than the diameter of said carrier shafts. The diameter center of each said throw is offset from the diameter center of each said carrier shaft. The distance of said offset of each said secondary crank throw cam is equal to the throw radius of said input throw cam. The direction of said offset of each of two said throw cams is diametrically opposite to the direction of said offset of the other said throw cam relative to said length axis of said carrier shaft. Thus, each two pair of throw cams form a crankshaft with two diametrically opposed throws.

Each length axis end of said torque divider consists of a wrist pin. Said pin is a short shaft, the length axis of which is at a right angle to said length axis of said divider. A bearing is located at each length axis end of said pin. Said two pin bearing support, one length axis end of one of two connecting rods. Said two rods transmit torque from said divider to said two secondary crankshafts. Each length axis end of each said rod is supported by a bearing on one said throw cam of one said secondary crankshaft, which receives torque from said rod. Each said other secondary crank throw cam of each said secondary crankshaft is connected to the body of said planetary by a bearing.

During direct drive, said carrier and said ring gear and output shaft rotate in the angular direction of torque input at torque input velocity. During maximum torque multiplication, said carrier remains stationary and said connecting rods drive said secondary crankshafts around said length axes of said carrier shafts. Said carrier shafts cannot counter-rotate in the opposite angular direction of torque input as to so would increase the rotational velocity of said secondary crankshafts around said carrier shafts therefore increasing the orbital velocity of said planetary gear. Mid-range load over torque ratios, result in a combination of said two movements.

During both said movements, the mass of the two connecting rod ends, which connect with said secondary crankshaft is always diametrically opposite to the mass of said planetary gear relative to said carrier shafts and thus the two said masses counter-balance each other. A counter-weight is also attached to said input shaft so that the mass of said counter-weight is diametrically opposite to the direction of the throw radius of said input cam, relative to said input shaft rotational axis, thus the mass of said counter-weight balances the mass of said torque divider.

1. A simple inherently self-regulating continuously variable torque transmission system.
